(19) United States
(12) Patent Application Publication
(10) Pub. No.: US 2007/0109913 A1
(43) Pub. Date: May 17, 2007

(54) Method and apparatus for preparing beverages

(75) Inventor: Shane Robert McGill, Kent (GB)

Correspondence Address: NIXON & VANDERHYE, PC, 901 NORTH GLEBE ROAD, 11TH FLOOR, ARLINGTON, VA, 22203, US

(73) Assignee: McGill Technology Limited, Kent (GB)

(21) Appl. No.: 11/600,283

(22) Filed: Nov. 16, 2006

Related U.S. Application Data
(60) Provisional application No. 60/836,974, filed on Aug. 11, 2006.
(60) Provisional application No. 60/837,316, filed on Aug. 14, 2006.

(30) Foreign Application Priority Data
Nov. 16, 2005 (GB) 0523341.6
Aug. 11, 2006 (GB) 0615958.6

(51) Int. Cl. A47J 43/042

(52) U.S. Cl. 366/205; 366/247

(57) ABSTRACT

A blended beverage is prepared using a first solid ingredient and a second liquid ingredient, the ingredients being stored in separate storage vessels, those vessels being coupled to one another. The liquid ingredient is intended to be poured from its storage vessel onto the solid ingredient, so that the solid and liquid ingredients can be blended together in the same storage vessel. The storage vessel into which the liquid ingredient is poured has a lid which carries an impeller for blending the ingredients together. The container may include an internal shoulder for seating the lid inside the walls of the storage vessel.

The present invention relates to a method for preparing beverages, in particular, but not exclusively, to a method for preparing fruit based beverages such as those commonly referred to as smoothies. The invention also relates to apparatus for producing such beverages and the like. The invention further relates to containers or drinks vessels, more particularly, but not exclusively, to containers or drinks vessels for use in dispensing blended beverages, particularly, but not exclusively, milkshakes and smoothies.

There is an increasing demand in the food service and catering industries for freshly prepared beverages. A popular beverage is known as a smoothie, which typically consists of a blend of fresh fruit pieces, fruit juice or syrup, and milk and/or yoghurt or ice cream, for example.

Food retail outlets have been known to serve smoothies prepared using conventional food blenders to blend the desired ingredients. However, a problem with such methods is that there can be extensive waste of product, due to difficulties in metering the correct amount of the various ingredients to be placed into the blender, alongside waste from the degree of product which is retained in the blender after serving. There is also a considerable labour cost associated with the preparation of the necessary ingredients and in cleaning the blender after each use.

A recent method of presenting and serving smoothies is to have fresh fruit, either pieces or whole fruits, packaged in a transparent container, hereinafter the “first” container. A “second” smaller container is filled with fruit juice or other liquid, then sealed and placed inside the first container, above the fresh fruit. A lid is then placed over the open end of the first container, thereby sealing in the fruit and second container. This combined package can then be placed into a self-serve display cabinet for self-selection, for example.

The combined package can be taken to a dispensing location, where the lid is removed from the first container and the seal is removed from the second container, so that the liquid from the second container can be poured onto the fruit in the first container. The fruit and liquid can then be blended into a smoothie by using a spindle blender, or other vertical blender lowered into the first container, for example. After blending, the original lid is refitted and the first container housing the smoothie is given to the consumer.

There are various problems with such a system. Firstly, the liquid volume inside the second container can never be sufficient to provide a full first container after blending. Therefore, other products, such as ice, must be added prior to, or after, blending to complete the fill of the container. Furthermore, the vertical blending mechanism must be cleaned after each blend to eliminate cross contamination and bacterial growth. Moreover, such vertical blenders are not simple to operate, in particular in an enclosed space such as a drinks vessel, thereby reducing the user's ability to ensure that the product is blended correctly.

It is an object of the invention to provide a method and/or apparatus and/or a container which addresses one or more of the problems referred to above.

It is known to blend a beverage, such as a milkshake, in an invertable container using a lid which carries an impeller type blending element, for example as shown in WO99/21466, WO2004/002281 and WO2005/013787. However, an inverted container may be susceptible to leakage, in particular if blending smoothies or the like using solid or frozen ingredients such as ice. The impact of the ingredients on the walls of the container during blending can lead to deformation of the container, thereby reducing the effectiveness of the seal between the lid and the container.

Therefore, there is a need for an improved method, apparatus and/or container which addresses the above problem, for reducing the risk of leakage during inverted blending, for example.

According to one aspect of the invention, there is provided an apparatus for dispensing a blended beverage, the apparatus comprising: a container for dispensing a blended beverage; and a blending lid for mounting over an open end of the container, the lid carrying a rotatable impeller; wherein the apparatus is intended to be inverted for the purpose of a blending operation, so that the lid is lowermost; and wherein the container is specifically configured for receiving the blending lid for the purpose of a blending operation.

The container is preferably a disposable, single-use item, preferably in the form of a beaker-type drinks vessel.

The container preferably has an open end and includes an internal step or shoulder spaced from the open end of the container. The shoulder is preferably intended for seating the lid on the container, e.g. for receiving a portion of the lid. The lid preferably includes an abutment surface intended to be seated on the shoulder inside the container. In preferred embodiments, the co-operation of shoulder and abutment surface provide a barrier against leakage from the open end of the container during blending.

The shoulder is preferably provided at a depth of at least 5 to 10 mm from the open end of the container, and is readily distinguished from any ridges, threads or steps that might otherwise be present immediately adjacent the rim of the container or that may form part of the rim of the container.

The lid may be configured to nest within the open end of the container, wherein side portions of the lid nest with internal surfaces of the container above the shoulder. The depth of the nesting engagement assists in reducing leakage from the container during blending, in particular where such nesting is annular. In preferred embodiments, the shoulder is located at a depth of between 10 mm and 30 mm. There are specifically preferred embodiments in which the shoulder is located at a depth of 5 mm to 15 mm, 15 mm to 25 mm, and 25 mm to 35 mm, respectively. However, for larger volume containers it may be preferred to locate the shoulder at a depth of 40 mm or more from the open end.

It should be clear that the step or shoulder referred to above should not be confused with ridges, ledges or steps that may be formed towards the base of the container, e.g. shoulders used for locating a heat sealed film or other such closure in the bottom of the container, or for supporting the base of nested containers. These type of ledges are shown in PCT/GB2006/001917.

It may be possible to reduce the depth of the lid and therefore the depth of the shoulder to as little as 2 to 3 mm from the open end of the container, particularly, but not exclusively, if the shoulder is somehow deformable so as to create a tightly nested or sealing effect with the lid. However, in such embodiments it should still be clear that a major purpose of the shoulder is to act as a seating for a portion of a blending lid inside the container, and that the shoulder is not merely a random aesthetic step or ridge like formation immediately adjacent the rim of the container or forming an actual part of the rim of the container.

The container preferably has a lip or rim projecting outwardly about its open end, and the lid preferably defines an annular slot or channel for snap- or friction fitting engagement over the rim, for secure location of the lid on the container when the lid is in abutment with shoulder.

In other embodiments, the lid can be permanently secured onto the container, for example by heat sealing.

The apparatus is preferably configured so that after the lid has been snap- or friction fitted over the rim of the container, the abutment surface of the lid may be initially spaced from the shoulder, e.g. wherein the annular slot in the lid defines a space above the rim of the container. Upon the application of subsequent pressure, e.g. a downward force on the lid, the abutment surface of the lid can be brought into contact or close proximity with the shoulder, reducing or removing the space above the rim of the container, e.g. to tightly engage the channel over the lip or rim.

The shoulder may be configured to deform under the application of pressure, for creating a tightly nested abutment with an underside portion of a lid applied to the open end of the container. In a simple embodiment, the shoulder comprises a bubble-type formation which is intended to deform inwardly when depressed. The shoulder may also define an initial angle with side walls of the container, e.g. so as to be upwardly oriented, but is intended to be displaced downwards from its initial angle, e.g. So as to be substantially horizontal or downwardly directed, by the application of pressure via the lid.

The container is preferably made of plastics material, e.g. by injection moulding, vacuum forming or blow moulding, as opposed to from paper or board type material.

The plastics container is preferably durable, so as to resist impact from material being blended within the vessel. This is of particular importance for beverages which are blended using frozen or semi-frozen components, particularly ice cubes or chunks of ice. The plastics material and the wall thickness of the container is preferably selected so that the container is suitably robust to resist splitting upon impact from ice chunks or the like during blending, and yet can be readily disposed of. The material is preferably able to resist fracture at sub-zero temperatures, e.g. for storing and blending frozen products. In applications where a vertical clamping load is to be applied to the main body of the container during blending, then the container is preferably strong enough to resist vertical clamping forces when inverted on a blending apparatus.

The container is preferably a disposable cup or beaker from which the blended beverage is intended to be consumed, e.g. using a straw or by drinking directly from container, the container being intended for only a single blending operation and dispensing operation, after which it is disposed of and/or converted to recycled material.

The container is preferably a disposable drinks vessel substantially of the kind known to persons familiar with the fast-food industry, e.g. for dispensing carbonated soft drinks and milkshakes. Such containers are configured to be crushable by hand, so as to be readily disposed of.

The preferred containers have tapering side walls, and are configured to be nested with other vessels of the same kind and configuration, one inside another, e.g. wherein the side walls of the nested vessels are arranged in close proximity substantially along their length.

According to another aspect of the invention, there is provided an apparatus for dispensing blended beverages, the apparatus comprising a disposable plastics container for dispensing the blended beverage, and a blending lid for mounting over an open end of the container, the lid carrying a rotatable impeller, wherein the apparatus is intended to be inverted for the purpose of a blending operation, so that the lid is lowermost, and wherein the container is specifically configured for receiving the blending lid.

According to another aspect of the invention, there is provided a single-use drinks vessel or beaker having a base and tapering side walls which define an open end of the beaker, the vessel being configured to be nestable with other vessels of the same kind and configuration, and the vessel being specifically configured for receiving a blending lid carrying an impeller, e.g. for use as part of an apparatus for preparing blended beverages in an inverted manner.

The term single use should be understood to mean that the drinks vessel is intended for use in a single beverage dispensing operation, wherein the blended product is consumed from the vessel container and the vessel is then disposed of and/or converted to recycled material. The term ‘single use’ is intended to distinguish this aspect of the invention from containers such as ceramic or glass cups or conventional blending jugs, for example, which are not intended to be a throwaway item, but are normally intended to be cleaned and reused for subsequent beverage dispensing operations.

The beaker preferably has internal step or shoulder spaced from the open end of the container. The shoulder can be used in conjunction with a blending lid to provide a barrier against leakage from the open end of the container during blending.

According to another aspect of the invention, there is an open ended container for dispensing a blended beverage, the container including an internal shoulder spaced from the open end of the container for seating a lid on the container inside the open end of the container.

The vessels, containers and beakers referred to above are preferably transparent or translucent, but incorporate a masked region adjacent the open upper end thereof, so that any detritus that might be left on the inside of the vessel adjacent its upper end as a result of blending, e.g. between the rim and the internal shoulder in the preferred embodiments, is not distinguishable through the walls of the vessel.

It is most preferred if the opaque region takes the form of a band, which may be provided integrally with the rest of the vessel, or may be printed or otherwise applied as a band to the outer or inner surface of the vessel. Alternatively, the band may take the form of an annular sleeve which can be slid on to the exterior of the vessel and then shrink fitted so as to be secured to the upper end of the vessel. The band may also be secured on the vessel by using a corresponding taper to the walls of the vessel. Such a sleeve may also serve as an insulator, to reduce any cold effect that might otherwise be experienced by a consumer when holding the vessel.

Accordingly, there is also provided a disposable drinks vessel having tapered side walls leading to an open end, the drinks vessel incorporating a sleeve which is shrink fitted or otherwise affixed to the external surface of vessel, to act as an insulator, to reduce any cold effect that might otherwise be experienced by a consumer when holding the vessel.

The sleeve may be locked on the vessel using a corresponding taper, for example.

The vessel is preferably made from plastics material, and may incorporate one or more the other features set forth above, such as an internal shoulder and/or a radially projecting lip.

According to another aspect of the invention, there is provided an apparatus for dispensing a blended beverage in container having a lid which carries a blending impeller, the apparatus comprising a base unit for receiving the combination of container and lid in an inverted orientation, the base unit having drive means for co-operation with the lid in rotating the impeller, and the apparatus having a clamping mechanism for securing the combination of container and lid in its inverted orientation, the clamping mechanism being movable from behind or from the side of the container when located on the base unit, said movement being in a direction substantially orthogonal to the axis of rotation of the impeller when so inverted on the base unit.

The clamping mechanism preferably comprises an arm which is movable to engage a peripheral portion of the container, and may move in a downward direction to engage the container after its movement in the direction substantially orthogonal to the axis of rotation of the impeller when so inverted on the base unit.

The clamping mechanism preferably includes an arcuate portion for engaging a correspondingly arcuate portion of the container, and may comprise opposing members for engaging opposite sides of the container.

The container preferably includes an external step adjacent its lower end when so inverted on the base unit, and the clamping mechanism is configured to engage the surface of the step that is uppermost when the container is so inverted on the base unit.

The container may include a channel around its lower end when so inverted on the base unit, and the clamping mechanism is configured to engage in the channel when the container is so inverted on the base unit.

According to another aspect of the invention, there is provided a method for producing a beverage blended from one or more primary ingredients and one or more secondary ingredients, the method including the step of providing an apparatus having a primary chamber for storing the or each primary ingredient, a lid to act as a removable closure for the primary chamber, the lid having a rotatable blending element which is connectable to drive means external to the apparatus for blending said primary and secondary ingredients, and a secondary chamber removably mountable on the apparatus for storing the or each secondary ingredient, the method including the further steps of charging the primary chamber with the or each primary ingredient, charging the secondary chamber with the or each secondary ingredient, mounting the secondary chamber externally on said primary chamber and storing the apparatus so charged, selecting the apparatus, removing the secondary chamber from the apparatus and emptying the secondary ingredients from the secondary chamber into the primary chamber, applying the lid so as to contain the primary and secondary ingredients within the primary chamber, and placing the lid in operative engagement with drive means external to said apparatus for driving said blending element, and blending said primary and secondary ingredients together in said primary chamber to create a blended beverage.

In a particularly preferred method, the apparatus is inverted for blending. The lid preferably provides an auxiliary chamber adjacent said primary chamber, for blending product within the auxiliary chamber when inverted.

The primary chamber is preferably in the form of a drinking vessel, whereby the blended beverage can be consumed directly from the vessel after blending. In a fast food type environment, this can be of particular advantage in reducing the need for cleaning of vessel after each blending operation. The drinking vessel is preferably substantially of a kind familiar to patrons of fast-food beverage dispensing environments, e.g. a readily disposable, relatively thin walled cup or beaker type container made of plastics or paper material, intended for a single use and not normally intended to be cleaned for subsequent use other than for recycling. More preferably, the drinking vessel is of a specifically modified form for co-operating with the lid and its blending element, e.g. configured so as to withstand the forces experienced during inverted in-cup/beaker blending, and/or to counter leakage that may be associated with inverted blending operations. Such features are referred to above, including the use of shoulder within the container for seating the lid of the container inside the container.

Preferably, the or each primary ingredient is in the form of fresh fruit pieces, and the or each secondary ingredient is preferably in the form of a liquid. By storing the ingredients in separate chambers, the integrity of the fruit pieces can be maintained, thereby enabling the preparation of a fresher form of blended product. Conveniently, the apparatus enables the fruit pieces to be stored in a freshly cut or whole state, free from suspension in the liquid required to provide the necessary blended product. Alternatively, the fruit can be packaged in the primary chamber in a deep frozen state or can be deep frozen after packaging. The secondary ingredient can also be chilled or deep frozen.

The apparatus is preferably stored at a refrigeration temperature after charging and prior to blending, e.g. for transportation from a charging location remote from a dispensing location or point of sale.

If deep-frozen products are being employed as primary and/or secondary ingredients, then the apparatus may be placed in a tempering cabinet at a dispensing or retail location, so as to warm up the product from its deep-freeze temperature to a higher, yet still refrigerated temperature. Where sub-zero Centigrade smoothies and other products are preferred to higher temperature products, then the tempering cabinet can be used to store the apparatus at below zero Centigrade temperatures suitable to ensure that the final blended product is also below zero Centigrade. The secondary ingredient may also be at this sub-zero Centigrade temperature but must still be in a liquid or semi-liquid or slush state at such temperature, suitable for pouring, at least at the point of sale, for example. Ice may be added prior to blending, e.g. at a point of sale, to give the same sub-zero Centigrade final product.

Preferably, the secondary chamber is mounted on a lower end of the primary chamber, and the two chambers, so mounted are then configured to be nestable with other such two-chamber arrangements of the same kind and configuration, so as to be capable of creating a stack of at least three and preferably five or more nested two-chamber combinations. The secondary chamber is preferably charged with ingredients prior to nesting in the manner mentioned above.

In a preferred embodiment, the primary chamber comprises a transparent material for viewing of product within the primary chamber prior to blending. This is of advantage in that it enables consumers or users to inspect the type, form and/or quality of the primary ingredients, to assist in selecting which beverage they require. This is of particular advantage is displaying to the consumer the freshness of the product they are about to prepare or purchase.

The lid may comprise a transparent material for viewing of the blending element during blending. This is of particular advantage in visually connecting the user with the blending procedure, which enhances the user's confidence in the freshness of the beverage they have selected.

According to another aspect of the invention, there is also provided an apparatus for preparing a blended beverage from one or more primary ingredients and one or more secondary ingredients, the apparatus including a primary chamber for storing the or each primary ingredient, and a lid to act as a removable closure for the primary chamber, the lid having a rotatable blending element for blending said primary and secondary ingredients, wherein a secondary chamber is mounted on the apparatus, externally of the primary chamber, for storing the or each secondary ingredient, the secondary chamber being removable from the apparatus for emptying the secondary ingredients into the primary chamber.

It is important to note that the secondary chamber preferably has a volume sized to match the amount of secondary ingredient required to make up a full beverage volume portion in the primary chamber after blending.

Preferably, an upper side of the lid includes a recess for receiving drive means external to the apparatus for rotating the blending element

The lid may be configured to provide an auxiliary chamber adjacent said primary chamber, for blending product within the auxiliary chamber, and may comprise a substantially dome shaped chamber.

The apparatus is preferably configured to be inverted in an operational blending mode for blending product from the primary chamber, e.g. in an automatic inversion machine such as shown in WO2004/002281.

In a preferred embodiment, the primary chamber is in the form of a vessel having a base and side walls diverging from said base so as to define an open upper end, and is preferably nestable with other primary chambers of the same kind and configuration (e.g. dimensions).

The primary chamber preferably has an open end, and the lid is preferably configured to be snap-fittingly retained over said open end. However, in some circumstances, the primary chamber may need to be filled with the primary ingredient(s), such as fresh fruit or fresh fruit pieces, at a remote location from the blending location. For such applications a tamper-evident removable heat-sealed diaphragm can be fitted to contain the ingredients in the primary chamber. This diaphragm would be removed at the blending location prior to blending.

The secondary chamber is also preferably in the form of a vessel having a base and side walls diverging from said base so as to define an open end, and is preferably nestable with other primary chambers of the same kind and configuration. It may also include a removable closure for sealing secondary ingredients within the secondary chamber. Snap-on or other interference fitting lids or closures may be used instead of the heat-sealed diaphragms.

The secondary ingredient may be sterile packed into the secondary chamber to allow it to be shipped to the point of sale at ambient temperatures, and giving a shelf-life of many months.

In a preferred embodiment, the secondary chamber is releasably fitted on the primary chamber, and may comprise a separate moulding adapted to be snap- or interference-fitted onto a lower end of the primary chamber. As such, the lower end of the primary chamber may include a rib or like formation, and the secondary chamber is preferably configured to engage with said formation to releasably retain the secondary chamber on the primary chamber. Alternatively, it may be a co-moulded chamber having perforations or the like for an easy twist and removal operation from the primary chamber.

According to a further aspect of the invention, there is provided an apparatus for preparing a consumable product from one or more primary ingredients and one or more secondary ingredients, wherein the apparatus includes a primary chamber for storing the or each primary ingredient, and a secondary chamber mounted externally of the primary chamber, for storing the or each secondary ingredient, wherein the secondary chamber is removable from the apparatus for emptying the secondary ingredients into the primary chamber.

The secondary chamber is preferably fitted over an open end of the primary chamber, to act as a temporary closure for the primary chamber, or may be removably fitted on to a lower end of the primary chamber.

One aspect of the invention further provides an apparatus for blending beverages comprising a container having a lid which carries an impeller, wherein the impeller is rotatably connectable to drive means external to the container and lid, the apparatus including a seating for receiving an inverted lid, and drive means for rotating the impeller, wherein the seating is provided in a housing, and wherein the housing includes means for heating the external surface of the container when positioned with its lid on said seating.

The housing preferably forms part of dedicated food blending machine, and may include a heatable cowl for positioning about the body of the container and/or may incorporate an air blowing device for directing warm air towards the container.

In a preferred embodiment, the housing is in the form of a chamber having a closure member, e.g. a door or window, which is openable so as to reveal an aperture through which the container can be introduced or removed from the chamber. The chamber and closure are preferably configured to substantially dampen the noise associated with the blending and/or heating operation, isolating the blending operation and thereby providing a safety barrier to prevent injury to a user during blending, for example if the container splits during blending.

There is also provided a method of preparing a blended beverage, including the steps of providing a mix of liquid and fruit product in frozen or semi-frozen form within a container, storing the container and its content at sub-zero temperature, applying a lid to the container, the lid carrying a blending impeller, inverting the united container and lid so that the lid is lowermost, and rotatably driving the impeller, wherein blending occurs in an apparatus having means for heating the external surface of the container, for encouraging substantially all of the frozen product within the container to move downwards to be blended by the impeller.

The content can be introduced to the container in unfrozen, semi-frozen or pre-frozen form.

One aspect of the invention provides a drinks vessel which incorporates a flexible band fixedly secured onto an outer region thereof, The flexible band comprise an elastomeric material, that can be stretched and passed over an end of the vessel, and then released so as to be engaged on the external surface of the vessel.

The band is preferably located between axially spaced projections, which may take the form of circumferential ribs, or radially spaced dimples. Alternatively, the band is located in an annular channel or recess, so as to be secured at a predetermined position along the axial length of the vessel. The vessel may incorporate a detent or the like adjacent or across said channel or recess, to enable a user to contact a rear portion of the band, so as to be able to remove the band from the vessel.

The band is preferably of a distinctive colour or surface marking or decoration, for example to denote a particular charity or other promotion, or to be indicative of the flavour of the product to be consumed from the vessel.

There is also provided a drinks vessel defining an annular internal surface, and an insert having a closure portion for locating in said vessel in a compression fit with said internal surface so as to define a storage chamber beneath said closure portion, the internal surface of the vessel including locating means arranged at a predetermined axial depth within the vessel for preventing undesired upward movement of the insert from within the vessel.

Preferably, the insert is a one piece object and includes an integral release arm configured to project the open end of the vessel when the insert is located in its desired position within the vessel.

Preferably, the locating means is in the form of an annular rib provided on the internal surface of the container, above the intended location of the closure portion of the insert in the container, so that the closure portion can be snapped over the rib and located at the desired axial depth in its compression fit with the internal surface.

In a preferred embodiment, the rib is replaced by an annular band of equidistantly spaced dimples, preferably covering up to a maximum of 50%, and more preferably only 25%, of the area otherwise covered by the rib, so as to reduce the potential for the generation of a line of weakness in the vessel walls in the region of the locating means, whilst still maintaining a suitable locking effect for the closure portion.

Other aspects and features of the invention will be readily apparent to the skilled addressee from the dependent claims and the following description, which is made, by way of example only, with reference to the accompanying drawings, in which:

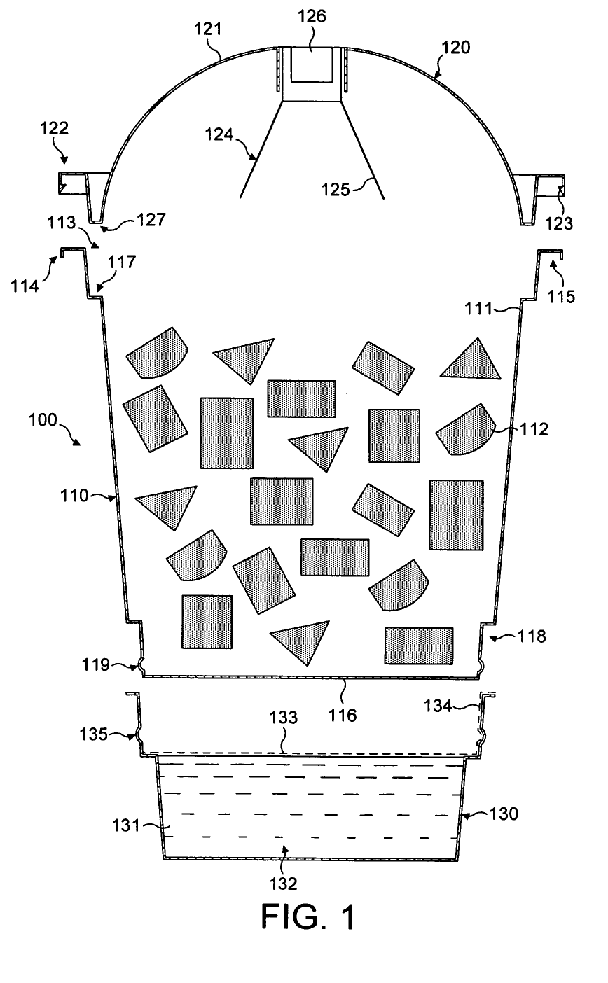

FIG. 1 is a schematic cross-sectional view of an apparatus for producing smoothie type beverages, showing the apparatus in an unassembled state;

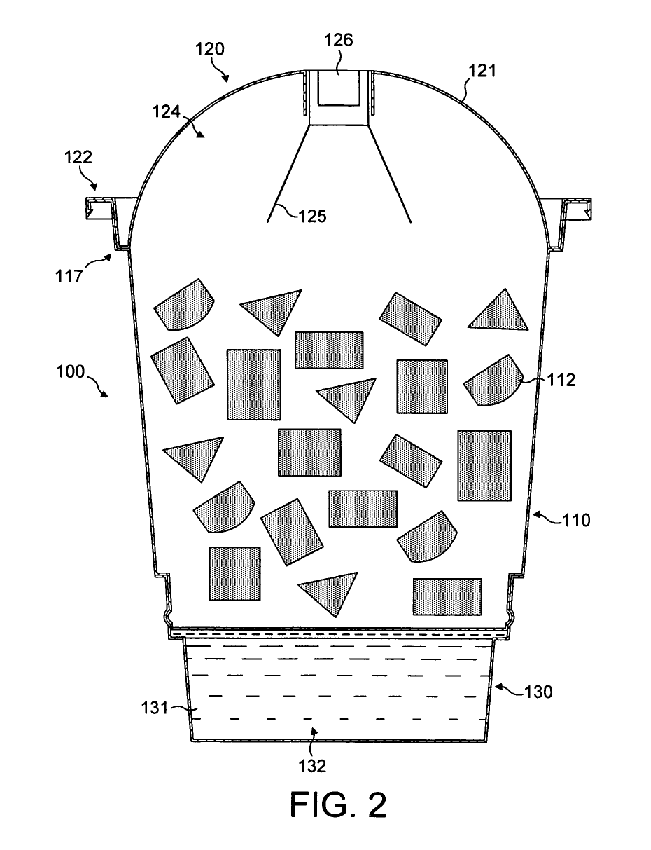

FIG. 2 is a view similar to FIG. 1, showing the apparatus in an assembled state;

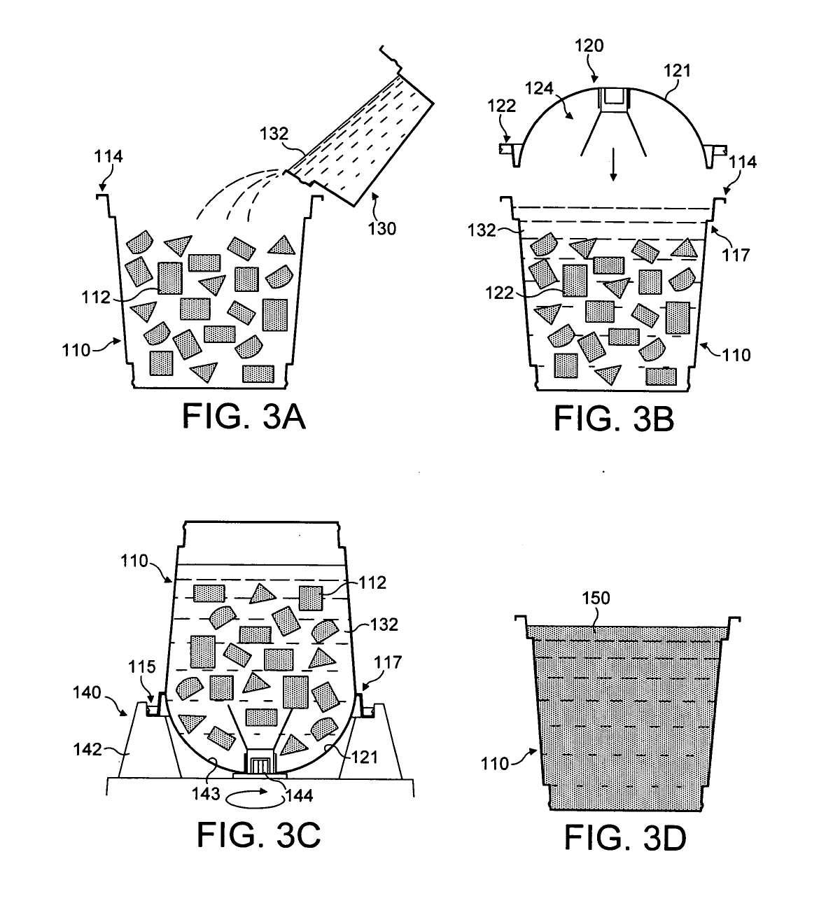

FIGS. 3A-3D are a series of schematic views showing the apparatus of FIGS. 1 and 2 being used to prepare a smoothie type beverage;

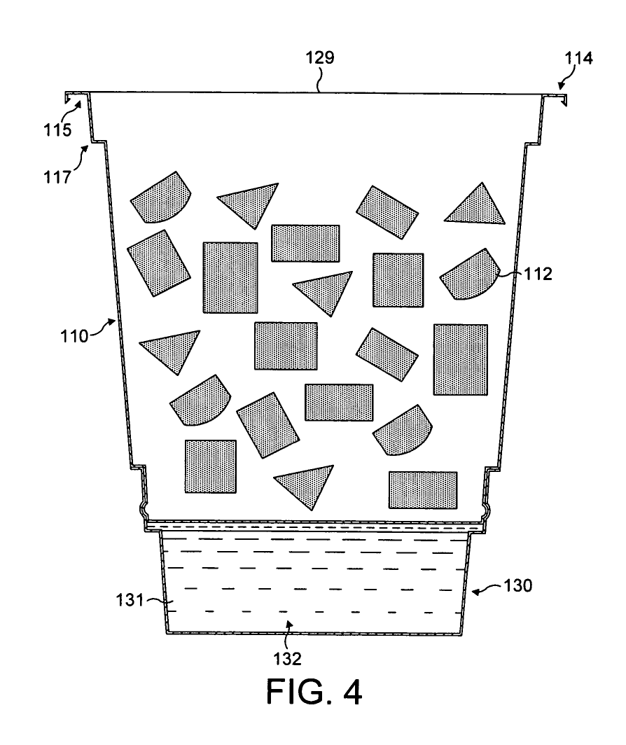

FIG. 4 is a view similar to FIG. 1, showing a charged and sealed container prior to the addition of the lid;

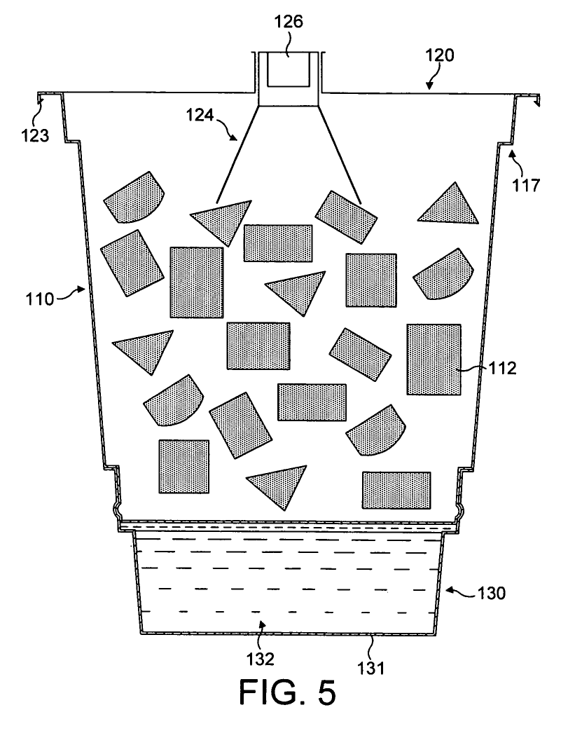

FIG. 5 is a view similar to FIG. 2, showing an apparatus with an alternative form of lid;

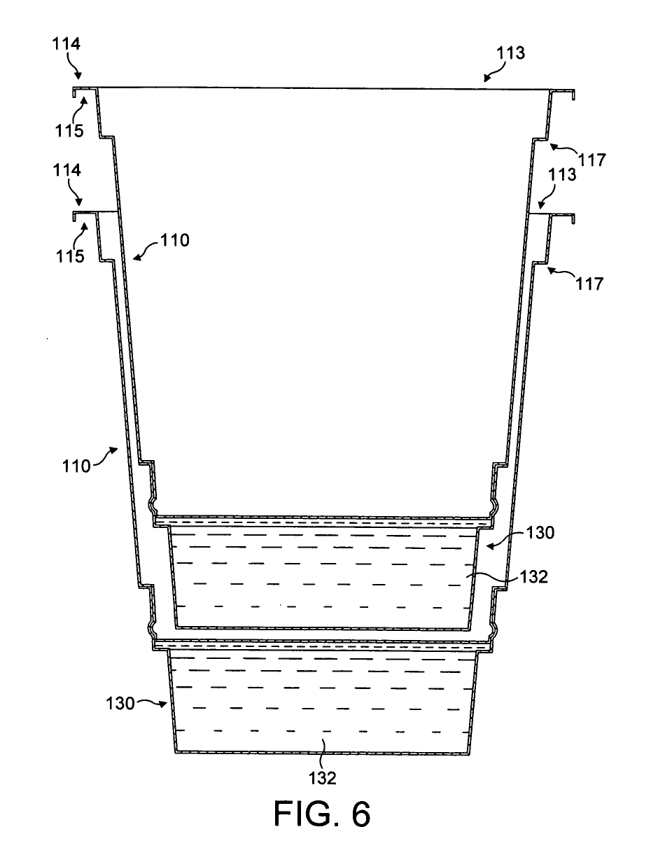

FIG. 6 is a view similar to FIG. 1, showing two multi-chamber combinations in a nested stack;

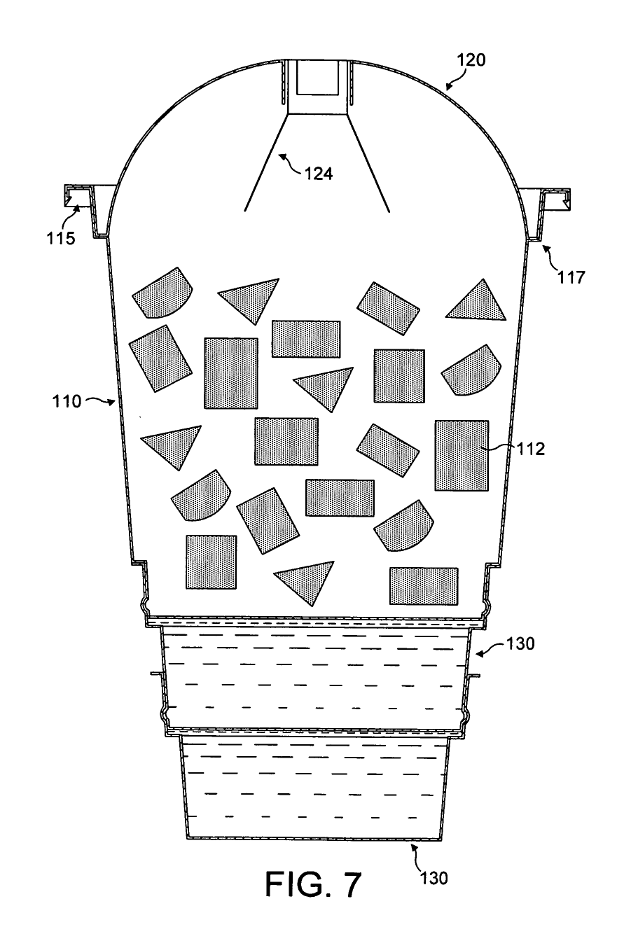

FIG. 7 is a view similar to FIG. 2, showing an alternative multi-compartment apparatus in an assembled state;

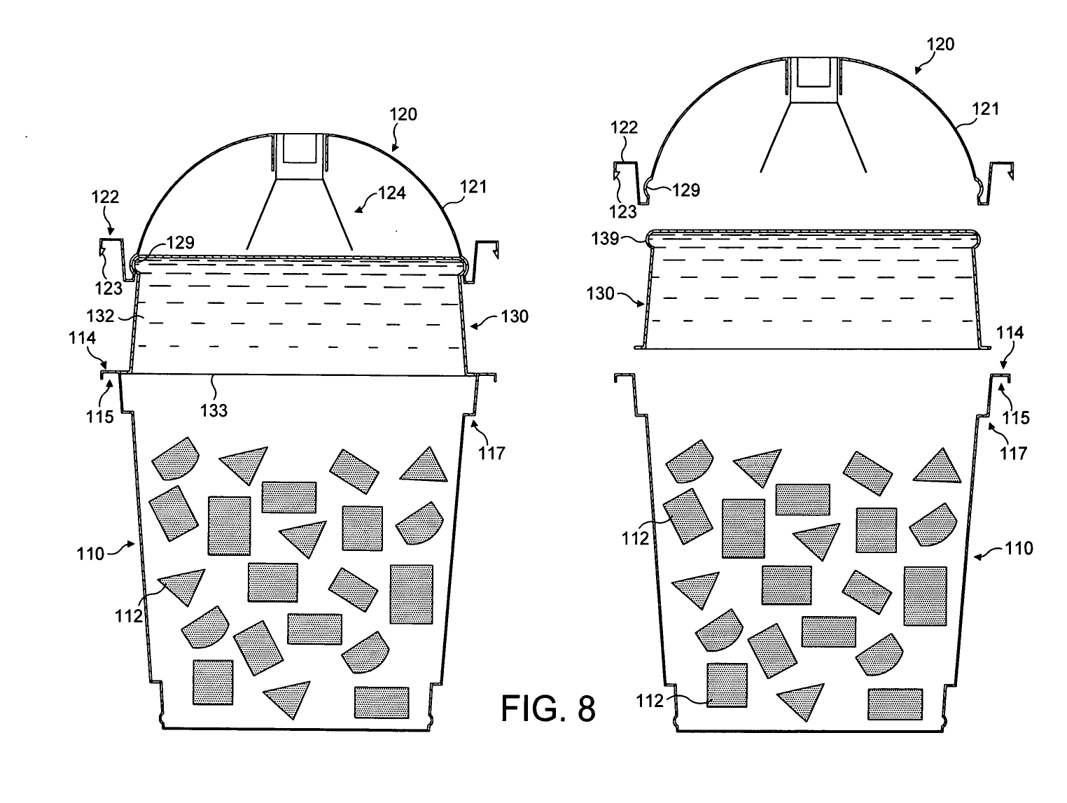

FIG. 8 is a view similar to FIG. 2, showing another embodiment of the apparatus in an assembled state;

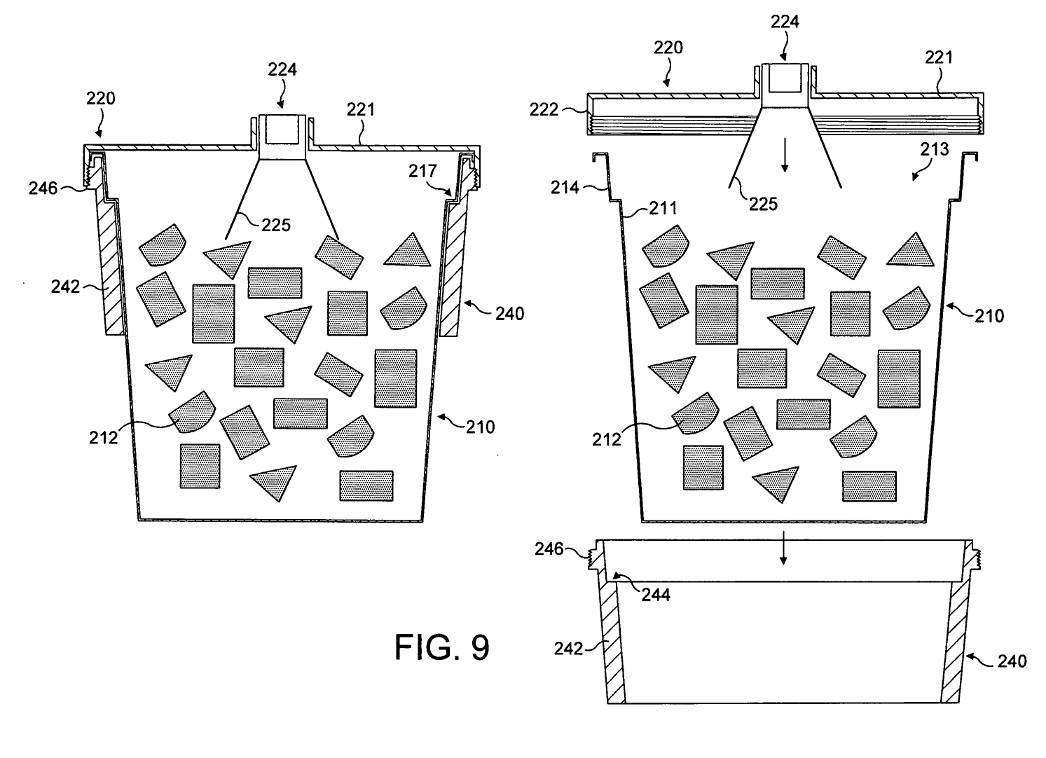

FIG. 9 is a view similar to FIGS. 1 and 2, showing a further embodiment of an apparatus for preparing a blended product;

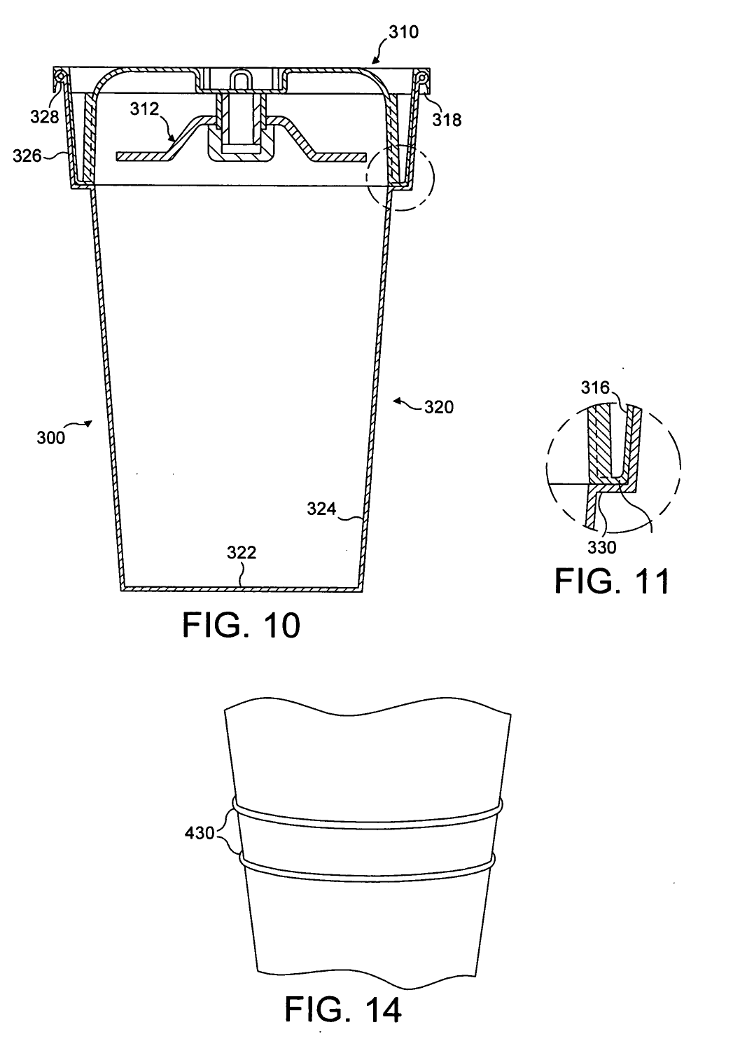

FIG. 10 is a schematic cross-sectional view of another apparatus for blending beverages;

FIG. 11 is an enlarged detail of the region encircled in FIG. 10;

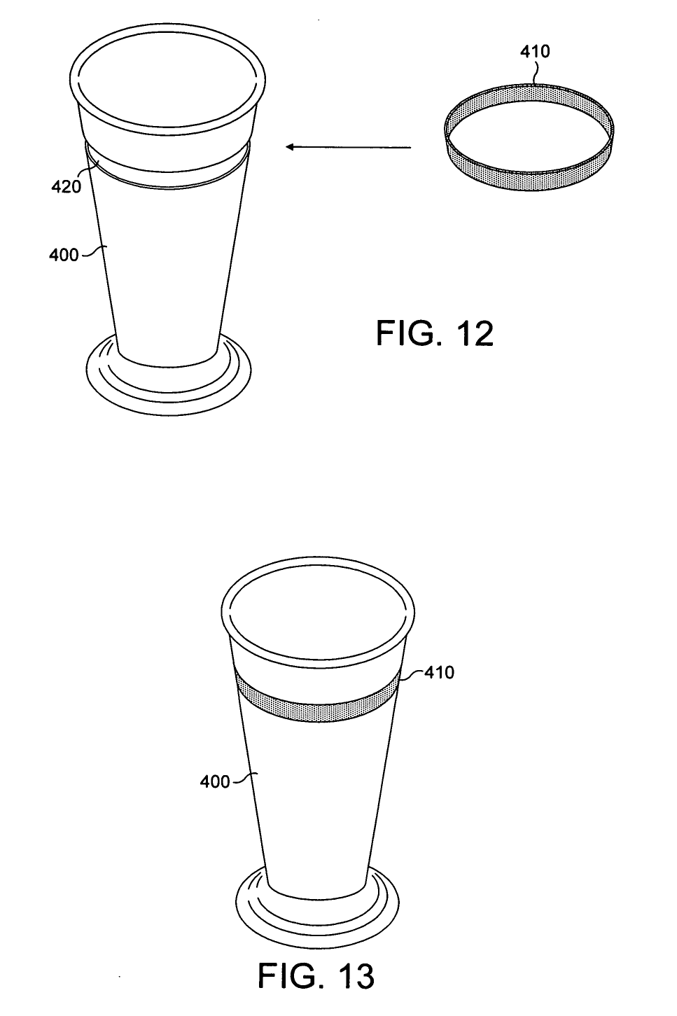

FIG. 12 is a schematic perspective view of a vessel for serving blending beverages, in an unassembled state;

FIG. 13 shows the vessel of FIG. 12 in an assembled state;

FIG. 14 shows an alternative detail for the vessel of FIG. 12;

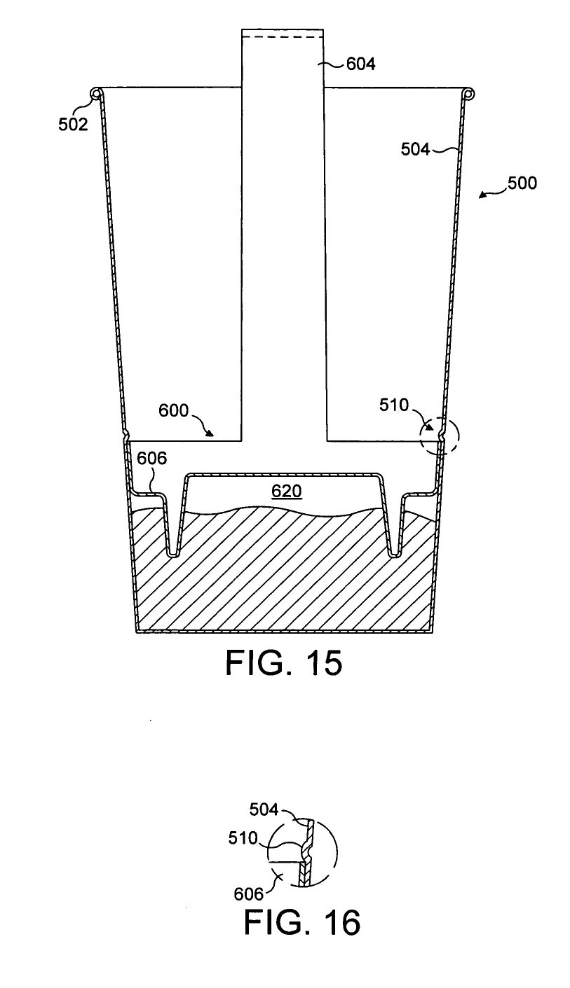

FIG. 15 is a schematic view through a section of a drinks vessel fitted with a removable insert;

FIG. 16 is an enlarged detail of the region encircled in FIG. 15;

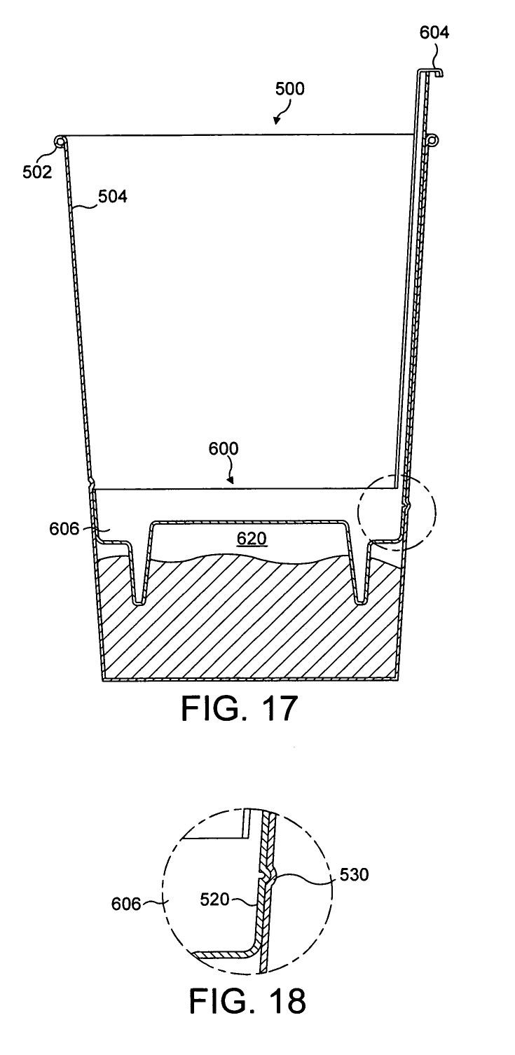

FIG. 17 shows a removable insert fitted inside a drinks vessel in an alternative manner to the insert of FIG. 15; and

FIG. 18 is an enlarged detail of the region encircled in FIG. 15.

Referring firstly to FIGS. 1 and 2, an apparatus for use in producing a smoothie type beverage is indicated generally at 100. The apparatus 100 consists of a container 110 having a lid 120, and a compartment 130 arranged to be removably fitted on the container 110.

In this embodiment, the container 110 is in the form of a large yoghurt pot or beaker type vessel, defining a generally tapered chamber 111 for storing fresh fruit or fruit pieces 112, such as grapes, strawberries, raspberries and other fruit berries, segments of citrus fruit, and slices or chunks of banana, pineapple, and the like.

An upper end of the container 110 defines an opening 113 having an outwardly extending rim 114 which defines a generally U-shaped channel or slot 115. In an alternative embodiment, the rim 114 may take the form of an outwardly extending annular bead.

The container 110 has a base 116 and side walls which are upwardly divergent from the base 116. A shoulder 117 is formed in the side walls of the container, adjacent its open end 113 but below the level of the rim 114, e.g. at a depth of 5 to 15 mm from the open end of the container. It should be clear that the shoulder is part of a marked step in the container, readily distinguished from the rim 114 of the container. The shoulder 117 is preferably annular, but may comprise discrete spaced formations projecting inwardly in other embodiments.

A similar shoulder or stepped region 118 is formed towards the lower end of the container 110, and a rib formation 119 is provided between the base 115 and the stepped region 118. The rib formation 119 is provided for retaining the compartment 130 on the container 110, as will be described below.

The lid 120 has a periphery indicated generally at 122 which is configured to nest in sealing engagement with the upper end of the container 110, as shown in FIG. 2. The lid includes a hook or nib 123 adapted to engage over the rim 114, so as to releasably retain the lid 120 in snap fitting engagement on the container 110. When so positioned, an underside portion of the periphery 122, as indicated at 127 in FIG. 1, is nested or located proximal with an internal surface of the shoulder 117 inside the container 110. This nesting or proximal relationship provides, amongst other things, an enhanced sealing effect to prevent leakage from the container during blending, as will be apparent from the description below.

The lid 120 defines a convex dome 121 which carries a rotatable impeller 124. The impeller 124 has rotor blades 125 for blending food/beverage ingredients within the region defined by the lid 120. The impeller 124 also includes a drive connection 126 by means of which the impeller 120 can be coupled with drive means external to the lid 120, for rotating the impeller blades 125, in a manner substantially as described in WO2005/013787, for example.

In this embodiment the compartment 130 defines a sealed chamber 131 for storing liquid 132 for use in the smoothie production such as a fruit juice, foaming agent and/or liquid stabiliser. A heat sealed film 133 provides a removable closure for the chamber 131, for storing and then gaining access to the liquid 132. The compartment 130 also has arms or an annular wall 134 adapted to snap fit onto the lower end of the container 110. In particular, the wall 134 includes a formation 135 which is complementary to the rib formation 119 on the container 1110, for releasably retaining the compartment 130 on the container 110. Hence, the container 110 is partially received in the compartment 130.

The apparatus 100 is preferably made from transparent material, in particular the container 110, for readily displaying the stored product, in use. A heat sealed film or other such removable closure 129 may be provided on the container 110 for storing the fruit or other product therein, as shown in FIG. 4, for example.

The apparatus 100 thereby provides an attractive storage vessel for ingredients for a fresh fruit smoothie, whereby a user or consumer may see the stored product. This is of particular advantage in a fast food or other food retail environment, wherein the consumer is able to visually inspect the stored product, prior to purchase.

The colour of the impeller 124 and/or the blades 125 is preferably visually distinctive, so as to be readily discernible within the lid 120.

The colour of the walls of compartment 130 can be chosen to represent the kind or flavour of the ingredients therein.

The provision of the domed lid 120 is advantageous, in that it enables the container 110 to be filled substantially to capacity prior to blending, and creates a further chamber above the container 110 for the blending process, such that blending occurs at least substantially outside the container, as will now be described with relation to FIG. 3.

Firstly, a user or consumer is able to view the apparatus 100, preferably in an assembled state, such as shown in FIG. 2. An array of filled containers 110 may be provided, each having a different fruit content. Equally, the content of the compartments 130 can be varied, so as to assist in preparing a different flavoured smoothie, for example. Hence, the user/consumer can choose which type of smoothie they desire.

Once a desired apparatus 100 has been selected, the compartment 130 and lid 120 are removed from the container 110. Any closure on the container 110 and/or the compartment 130 is then removed, so that the content of the compartment 130 can be emptied into the container 110 through the opening 113 (see FIG. 3A).

The lid 120 is united with the container 110 in a sealed arrangement, so that the apparatus 100 is ready for blending (see FIG. 3B). The compartment 130 is then disposed of.

A preferred blender unit is illustrated in FIG. 3C at 140, and includes a seating 142 having a surface 143 configured for receiving the lid 120 in an inverted state, in particular in a concave surface for nesting engagement with the domed surface 121 of the lid 120, with the drive means 144 extending up from the seating 142 for engagement with the drive connection 126.

Once inverted and positioned on the seating 142, a pressure plate or other retaining means (not illustrated) can be used to secure the container and lid combination in the inverted blending position as shown in FIG. 3C.

In one embodiment, the seating 142 forms part of a blending apparatus having a claw or clasp mechanism which is operable to engage the channel 115 or the shoulder 117. The claw or clasp preferably moves from behind or from the sides of the inverted container in a substantially horizontal direction, orthogonal to the axis of rotation of the impeller as viewed in FIG. 3C, before being moved down, preferably only a short distance, into clamping engagement with the channel 115 and or shoulder 117 of the container 110.

It will be appreciated that, with the combination of lid and container inverted as shown in FIG. 3C, the fruit and liquid ingredients within the container 110 will be caused to fall into the chamber defined by the lid 120, so as to be brought into contact with the blades 125 of the impeller 124. The blender unit 140 is then utilised to drive rotation of the impeller to blend the fruit pieces together with the other ingredients, so as to create a fresh fruit smoothie.

The combination of lid 120 and container 110 is then removed from the seating and turned upright, so that the lid 120 can be removed to gain access to the blended smoothie 150 (see FIG. 3D). Alternatively, a tab (not illustrated) on the lid 120 can be removed to enable a straw to enter the container 110 through the lid 120, to access the blended product.

In some circumstances, the compartment 130 will not be required, and the addition of liquid to the fruit pieces within the container 110 can be made from another source prior to fitment of lid 120.

In the illustrated embodiment, it should be noted that the impeller is arranged within the chamber defined by the lid 120, and does not extend into the container 110 when the lid is fitted thereto. This enables the container 110 to be filled substantially to capacity with solid fruit pieces, prior to blending, thereby ensuring a substantially full container of blended product after blending.

An alternative embodiment is shown in FIG. 5 using corresponding reference numerals, wherein the lid 120 has a substantially planar surface 121, and whereby the impeller extends into the container 110, in use.

In a preferred method, the volume of liquid in the compartment will be predetermined so that, when added to the fruits in container 110, it will provide a completely filled container 110 consisting of the fruits plus the added liquid.

It is often desirable to have the blended smoothie at a sub-zero or very low temperature and therefore the assembled container as shown in FIG. 2 may desirably be displayed in a display cabinet having a temperature below zero to create this sub-zero effect upon the finished product. Under such circumstances the liquid in the compartment 130 would be formulated and/or contain such fructose or other ingredients to ensure that, at such a low temperature, the solution of product would remain unfrozen or in a pourable slush condition so that it may be poured conveniently into container 110 prior to blending. After blending, the finished blended smoothie would have the effect of being a frozen blended smoothie or a highly chilled blended smoothie, thus eliminating the need for added ice or other chilled medium.

The liquid in the compartment 130 may be of a concentrated nature so that it may be added to container 110 together with ice so that after blending the final product is of a desired percentage of fruit or other product for the final smoothie.

Clearly, given the substantially different nature of the primary and secondary ingredients, i.e. solid or substantially solid fruit pieces in the container 110 and liquid in the compartment 130, the container 110 and compartment 130 would be charged with ingredients separately, for example using different filling machines, typically at separate charging locations.

It will be appreciated that the illustrated embodiment, wherein the container 110 is partially received in the compartment 130, enables preferably charged compartments 130 to be fitted onto empty containers 110, and the combination of empty container 110 and the charged compartments 130, to be nested one inside another, as shown in FIG. 6.

Two or more compartments 130 can be fitted onto the bottom of the container 110 or onto the lid 120, in a stacked manner, wherein a first such compartment is releasably retained on the lower and of a second compartment, in any suitable manner, such as those described above between the container 110 and compartment 130, as illustrated in FIG. 6. Each compartment could have a different ingredient, e.g. a solid ingredient, such as nuts or chocolate pieces, in one, and a fruit juice in another. It will be appreciated that a ‘multi-compartment’ apparatus of the kind illustrated in FIG. 7 is readily nestable in the manner shown in FIG. 6.

Although the illustrated embodiment shows that the compartment 130 is adapted to be releasably retained on the container 110, in alternative embodiments it may be configured to be fitted on a side portion of the container 110. A further embodiment is illustrated in FIG. 8, using the corresponding reference numerals, wherein the compartment 130 is mounted between the lid and the container 110. As can be seen, the compartment 130 includes a snap-fitting periphery 138 of a kind similar to the periphery of the lid 114, so that the compartment 130 can be inverted and engaged over the periphery 114, to act as a closure for the open end 113 of the container 110. A heat sealed closure 133 is provided over the open end of the compartment 130.

It can also be seen that a rib formation 139 is provided adjacent the base of the compartment 130, for engagement with a correspondingly shaped formation 129 on the periphery of the lid 120. This enables the lid 120 to be releasably secured on the compartment, substantially in the manner of the connection between the compartment 130 and the container 110 in FIGS. 1 and 2. However, once the compartment 130 has been removed, the lid 120 is capable of engagement with the rim 114 of the container 110, as described in the previous embodiments.

The above described embodiments show apparatus for preparing a blended beverage or other consumable product from one or more primary ingredients, for example fresh fruit, whether whole or in pieces, and one or more secondary ingredients, for example milk, ice-cream, yoghurt and fruit juices. In each case, the apparatus includes a primary chamber for storing the or each primary ingredient, and a secondary chamber mounted externally of the primary chamber, for storing the or each secondary ingredient, wherein the secondary chamber is removable from the apparatus for emptying the secondary ingredients into the primary chamber. A lid is used to act as a removable closure for the primary chamber, the lid having a rotatable blending element for blending said primary and secondary ingredients. However, the applicant hereby reserves the right to apply for patent protection for the various combinations of primary and secondary chamber described and illustrated herein, independent from the lid.

A further apparatus 200 is illustrated in FIG. 9, having a container 210, a closure 220 and a collar 240.

The container 210 corresponds generally with the containers 110 described above. As such, corresponding features will not be described in detail. It should be noted that the container 210 is in the form of a beaker type drinks vessel, defining a generally tapered chamber 211 for storing fresh fruit or fruit pieces 212. An upper end of the container 210 defines an opening 213 having a rim wall 214 terminating in an outwardly directed flange that defines a substantially u-shaped channel. The container 210 may include a lower region for connection with a removable compartment 130 of the kind described above, although this is not shown in FIG. 9.

The lid 220 has a generally planar upper surface 221 and a periphery 222 which is configured to sit over the rim flange at the end of the rim wall 214. The periphery 222 of the lid 220 includes an internal thread 227 for engagement with a threaded outer surface on the collar 240. The lid 220 carries an impeller 224 having blades 125 which extend into the chamber 211 in the container 210, in use.

The collar 240 has tapered side walls 242, which are configured to receive the container 210 in a close fitting relationship. The side walls 242 include an internal annular shoulder 244, which is configured to support the underside of a similar shoulder 217 on the container 210, so that the container can be freely supported on the collar 240. The collar 240 has an external screw thread 246 for threaded co-operation with the lid 220, although other suitable retention means can be used.

In use, the charged container 210 is fitted into the collar 240. The lid 220 is placed over the opening 213 of the container 210 and is secured onto the collar 240, in this case by threaded engagement, so as to clamp the rim 214 of the container 210 between the collar 240 and the lid 220.

The apparatus 200 is then ready for connection to external blending means, for example in the manner illustrated in FIG. 3C.

The apparatus 200 is of particular advantage if the container 210 is made from thin walled or relatively flimsy material, whereby the collar 240 provides external support to the container 210, so as to resist twisting process that might be experienced by the container 210 during blending, that might otherwise damage or deformation of the container 210. The collar 240 can also provide a reaction force against ice cubes or other solid or frozen ingredients that may be thrown against the side walls of the container during blending.

Whereas it may be preferred to have the lid and blending impeller of the earlier embodiments made from a plastic material, perhaps suitable for only a single blending operation, the lid in FIG. 9 is preferably of a reusable construction having steel blades or the like so as to able to withstand multiple blending operations, in particular for blending ice cubes or the like. The collar and lid can be washed after each blending operation.

Although the described embodiments refer to the preparation of blended beverages, the various embodiments can also be used to prepare consumable products from two different ingredients, blended or otherwise combined.

It may be preferable to provide a mix of liquid and fruit product in frozen form within the containers referred to above, for storing at sub-zero temperatures prior to blending. The charged containers can then be placed in a tempering cabinet, prior to blending, to bring them up to a blending temperature, for example −1 to −4 degrees centigrade. The united combination of lid and container can then be selected for blending in an apparatus, for example of the kind referred to in the applicant's International Patent Applications WO 2005/013787 or WO 2004/002281.

However, it may be advantageous to use a modified blending apparatus having a chamber for receiving the containers, wherein blown hot air and/or a heated cowl can be applied around or directly to the outer surface and/or base of the container, within a chamber in the housing. Preferably, this occurs when the containers are in position for a blending operation, e.g. inverted with the blending lid lowermost, so as to encourage substantially all of the frozen product within the container to slip downwards in to the blending zone, to ensure thorough blending of the entire frozen ingredients, and to avoid large sections of frozen product being left attached to the walls of the container during blending.

FIG. 10 shows an apparatus 300 for dispensing blended beverages, the apparatus 300 having a blending lid 310 which carries a rotatable impeller 312, and a specifically modified drinks vessel 320.

It will be understood that the impeller is rotatably drivable via separate drive means external to the apparatus 300, for example substantially as described in the applicant's International Patent Applications WO 2005/013787 or WO 2004/002281, which are incorporated herein by reference. As such, it is preferred if the apparatus is inverted for the purpose of a blending operation, such that the lid 310 is lowermost.

The drinks vessel 320 is in the form of a beaker, most preferably a plastics item, having a base 322 and tapering side walls 324, 326 which extend to an open upper end. An outwardly directed lip 328 is provided about the open end.

As can be seen, a pronounced step region which defines an annular shoulder 330 is provided at an upper region of the vessel 320. This shoulder 330 is specifically intended to serve as a seating for an underside portion 314 of the lid 310, as can be seen most clearly from FIG. 11. Moreover, the taper of the side walls 326 above the shoulder is configured to match the taper of an outer wall 316 of the lid 310, so that the lid 310 can be nested in the upper end of the vessel 320, supported on the shoulder and in frictional engagement or approximate abutment with the internal surface of the vessel 320. The depth of the shoulder 330 is preferably selected to match the depth of the lid 310, so that the two items are preferably configured specifically to be united with one another, with the out-turned rim 318 of the lid 310 engaged over the lip 328 of the vessel 320 when the underside portion 314 of the lid 310 is in abutment with the shoulder 330.

In this embodiment, the shoulder 330 is provided at a depth of approximately 30 mm from the open end of the container, markedly spaced from the open end of the container and wholly distinguished from the rim of the container. On other embodiments, the shoulder may be located at a depth of 5 mm to 15 mm, 15 mm to 25 mm, or 25 mm to 35 mm, for example.

The provision of the shoulder 330 at a depth which matches the depth of a blending lid intended to be received inside the open end of the container is advantageous in that it provides a convenient means for user to readily detect whether the lid 310 has been correctly located on the vessel 320. Perhaps more importantly, a first seal or barrier to leakage can be achieved between the step region of the vessel 320 and the lid 310, in addition to the seal or barrier which would typically be provided between the lid 310 and the lip 328 of the vessel 320. By ensuring that the taper of the internal surface 326 above the shoulder 330 matches the taper of the external wall of the lid 316, a sliding fit can be provided between the lid 310 and vessel 320, which acts as an axial leak-proofing, in addition to the seals provided at the lip 328 and shoulder 330.

In a preferred embodiment, the arrangement is such that after the lid 310 has been fitted over the lip 328 of the vessel 320, the underside portion 314 of the lid may be spaced from the shoulder 330, and wherein the rim 318 of the lid 310 defines a space above the lip 328 of the vessel. A user may then apply pressure to the lid and/or vessel so as to bring the underside portion 314 of the lid 310 into abutment with the shoulder 330, as shown in FIG. 11. The shoulder 330 can be specifically configured to deform under this application of pressure, for example to create a tightly nested abutment with the underside of the lid. In one example, the shoulder includes or defines a bubble type formation which is intended to be depressed by the lid. Alternatively, the apex of the shoulder may be upwardly directed, e.g. to define an acute angle with the side walls 326, and intend to be displaced downwards, e.g. to a right angle, by the lid.

The stepped region has an additional advantage in that it strengthens the vessel 320 at a potentially critical region, i.e. generally adjacent the level of the impeller 312 when the lid 310 is united with the vessel 320, to provide reinforcement to resist twisting forces experienced by the walls of the vessel 320 during high speed blending within the vessel 320. The shoulder 320 is preferably provided at an axial depth corresponding to at least the depth of the lid, but may also be provided below this level.

Similar or corresponding advantages of strength, rigidity and sealing are achieved by the upper stepped region shown in the container 110 of FIG. 1 and FIG. 7, for example.

It is preferred if the vessel 320 is made from plastics material as a moulded item, which provides durability for resisting impact from material being blended within the vessel, for example solid ice material, in particular ice cubes. The plastics material should be of a kind and thickness which renders the vessel 310 readily disposable after a single use, but suitably robust to resist splitting upon an impact from ice cubes of the like during a first blending operation. The vessel is also preferably configured to be able to withstand the vertical clamping pressures associated with blending apparatus of the kind referred to in the applicant's International Patent Applications WO 2005/013787, for example, so that the vessel can be held in position using a mechanical retainer engaged against its base to clamp the container in an inverted blending position, without compressing.

A simplified, yet preferred embodiment takes the form of a disposable plastics drinks vessel, having continuous (no shoulder) tapering side walls leading to an open end, preferably having a radially projecting rim or lip, the vessel being configured to be nested with other vessels of the same tapering side walls, one inside another, wherein the side walls of the nested vessels are arranged in close proximity substantially along their length. The plastic drinks vessel preferably takes the form of a beaker, most preferably without an integral handle or the like, and more preferably comprises part of an apparatus for use in blending beverages, the apparatus further comprising a blending lid, for example of the kind shown in FIG. 10, having an impeller and being specifically configured for use on the vessel.

The term disposable used in relation to the above embodiment should be understood to mean that the vessel is intended for use in a single beverage dispensing operation, wherein a beverage is blended in the vessel, the beverage is then consumed from the vessel, and the vessel is then disposed of and not reused for a subsequent blending operation.

The specifically configured disposable plastics drinks vessels referred to herein are a particularly advantageous alternative to the kind of paper cups traditionally used for dispensing milkshakes and the like in a fast food environment, especially in the production of beverages using solid ingredients, in particular solid ice.

In the illustrated embodiment of FIG. 10 or the non-illustrated embodiment referred to above, it is preferred if at least a portion of the container is translucent, so that a consumer can view the product in the container through the walls of the vessel during or after blending. However, it is also preferred if at least the upper region of the vessel is opaque or suitably distressed, so as to mask any detritus that might be left on the inside of the vessel as a result of blending, so as not to be readily visible through the walls of the vessel.

It is most preferred if the opaque region takes the form of a band, which may be provided integrally with the rest of the vessel, for example as a thermally distressed section, or take the form of a printed band. The band may take the form of a separate object applied to the outer surface of the vessel, for example an annular sleeve which can be slid on to the exterior of the vessel and then shrink fitted so as to be secured to the upper end of the vessel. Such a sleeve may also serve as an insulator, to reduce any cold effect that might otherwise be experienced by a consumer when holding the vessel.

The various forms of opaque or distressed region referred to above may also be utilised on any of the other containers or vessels described or illustrated herein. On those embodiments that incorporate a shoulder, a cardboard or other insulating sleeve may be fitted around the body of the container, beneath the shoulder.

In any of the embodiments described herein, it may be preferable to provide a concave portion on the base of the container/vessel, i.e. extending upwardly into the vessel. During blending, pressure may build up within the vessel, which may act to push the concavity outwards. However, after blending, the outwardly urged region can be depressed, so that pressure created within the within the container/vessel can be evacuated through the open end of the container, around the lid, and/or through the shaft which locates the impeller on the blending lid.

Additionally, or alternatively, at least one axially extending channel or recess can be formed in either of the axially engaging surfaces of the lid and vessel/container, preferably at least to a depth which corresponds to the axial depth of the lid. This can be true for both paper and plastics vessels/containers. The purpose of the channel or recess is to allow air egress when positioning the lid inside the open end of the vessel, and to reduce or release any vacuum formed inside the united lid and vessel during blending, to enable easy removal of the lid after blending. Typically, the channel or recess will have only a small cross-section, no greater than 1 mm.

FIGS. 12 and 13 show a goblet type drinks vessel 400 made from plastics material, for use in serving blended beverages. The vessel 400 incorporates a flexible band 410, for example of an elastomeric material, that can be stretched and passed over an end of the vessel 400, and then released so as to be engaged on the external surface of the vessel 400.

In the illustrated embodiment, the band 410 is located in an annular channel or recess 420 so as to be secured at a predetermined position along the axial length of the vessel 400. However, the band 410 may alternatively be secured between outwardly extending formations, such as a pair of axially spaced circumferential ribs (see 430 in FIG. 14).

A slot or other detent is preferably incorporated adjacent or across one of the ribs or channels, to enable a user to place their finger behind at least a portion of the band, so as to be able to remove the band from the vessel, after consumption of a beverage from the vessel, for example.

The band 410 is preferably of a distinctive colour or may be otherwise suitably marked, so as to denote a particular charity or promotion, or to be indicative of the flavour of the product to be consumed from the vessel, for example.

The band 410 and the means 420, 430 of securing the band 410 can be applied to any of the containers/vessels described herein.

It may also be desired to incorporate an additional or alternative band in a hollow base portion of the vessel, for example an annular channel in the base, to be removably retained in the base of the vessel by clip means or the like. Such a band is preferably housed within the vessel, but is also viewable through the vessel. The band preferably takes the form of an illuminous or illuminated band, e.g. formed from a light stick or glow stick or similar material, wherein a chemical reaction to excite the atoms in the material to create chemiluminescence.

FIG. 15 shows a further modified drinks container 500 and a one-piece insert 600 to be received in the vessel 500, substantially in the manner described in the applicant's co-pending International patent application, PCT/GB2006/001917, which is incorporated herein by reference.

The insert 600 has an integral release arm 604 which projects rigidly from a ring-type closure portion 606. The release arm 604 is of a length which is selected so as to project from the open end of the container 500 in use. This is advantageous, in that the distal end of the arm 604 can be handled without contacting the rim of the container during removal of the insert 600, obviating hygiene concerns about contamination of the lip 502 of the container 500.

The closure portion 606 has an outer peripheral wall which is configured to be arranged in a compression fit with the internal shape of the container 500, for defining a storage chamber 620 beneath the insert 600. The insert 600 is nestable in a stack with other inserts of the same kind and configuration, and may include anti-rotation features, on the arm and/or closure portion, to resist rotation between adjacent inserts in a stack.

An annular rib 510 is provided on the internal surface 504 of the container, just above the intended location of the closure portion 606 of the insert 600 in the container 500. The rib 510 is used to temporarily lock the closure portion 606 of the insert 600 in place, to prevent unintended upward movement the closure portion 606.

In a preferred embodiment, the rib 510 is replaced by an annular band of equidistantly spaced dimples, preferably covering up to a maximum of 50%, and more preferably only 25%, of the area otherwise covered by the rib 520, to reduce the potential for the generation of a line of weakness in the container walls, whilst still maintaining a suitable locking effect.

In FIG. 17, the rib 520 is provided on the closure portion 606 of the insert 600, to be lockingly received in a complimentary recess 530 formed in the internal wall of the container 500, at a predetermined axial depth from the open end of the container 500. The recess 530 is preferably annular, whereas the rib can be replaced with spaced dimples of the kind and spacing referred to above. The rib or dimple can be formed by pushing out a portion of the closure portion, as illustrated, or be formed by additional material extending from the closure portion.

In each of the embodiments of FIGS. 15 to 18, the closure portion 606 is locked against undesired upward movement relative to the container walls, and the insert 600 is intended to be releasable from within the container 500 only when the distal end of the release arm 604 is pulled upwardly away from the open end of the container 500.

It will be understood that one or more ribs, recesses or sets of dimples can be provided in the containers, axially spaced from one another, for receiving and locking different diameter closure portions in place, as required, so as to increase or decrease the size of the storage chamber 620.

1. A disposable beaker for use as part of an apparatus for preparing a blended beverage, wherein the beaker has an open end and includes an internal shoulder spaced from its open end for seating a lid inside the open end of the beaker.

2. A beaker according to claim 1, wherein the beaker includes a radially projecting rim or lip about its open end and the shoulder is formed below the rim or lip.

3. A beaker according to claim 1, wherein the shoulder is provided at a depth of between 5 and 40 mm from the open end of the beaker.

4. A beaker according to claim 1, wherein the shoulder is specifically configured to deform under the application of pressure, for creating a tightly nested abutment with an underside portion of a lid applied to the open end of the container.

5. A beaker according to claim 4, wherein the shoulder comprises a bubble-type formation which is intended to deform inwardly when depressed.

6. A beaker according to claim 4, wherein the shoulder defines an initial angle with side walls of the container and is intended to be displaced downwards from its initial angle.

7. A beaker according to claim 1, wherein the shoulder is formed by an annular step in the side walls of the beaker.

8. A beaker according to claim 1, wherein the beaker is made from a plastics material and is configured to be manually crushable, so as to be readily disposed of.

9. A beaker according to claim 1, wherein the beaker has tapering side walls, and is configured to be nested with other beakers of the same kind and configuration, one inside another.

10. A beaker according to claim 1, wherein the beaker is transparent or translucent, but incorporates a masked region adjacent the open upper end thereof, so that any detritus that might be left on the inside of the vessel adjacent its upper end as a result of blending is not distinguishable through the walls of the beaker.

11. A beaker according to claim 10, wherein the masked region takes the form of either a distressed portion of side wall, a band printed directly onto the beaker, or a band otherwise applied to the outer surface of the vessel.

12. A beaker according to claim 10, wherein the masked region takes the form of an annular sleeve which can be slid on to the exterior of the vessel and then shrink fitted so as to be secured to the upper end of the vessel.

13. Apparatus for dispensing blended beverages, the apparatus comprising a container for dispensing a blended beverage, the container having an open end, and a blending lid for mounting over the open end of the container, the lid carrying a rotatable impeller arranged for driving connection with drive means external to the lid and container, wherein the lid includes side walls which define a blending chamber about the impeller, and wherein the container includes an internal shoulder spaced from the open end of the container for seating the walls of the lid inside the open end of the container.

14. An apparatus according to claim 13, wherein the container comprises a disposable plastics container.

15. An apparatus according to claim 13, wherein the container includes a radially projecting rim or lip about its open end.

16. An apparatus according to claim 13, wherein the lid includes an abutment surface intended to be seated on the shoulder inside the container.

17. An apparatus according to claim 16, wherein the lid defines a channel configured to be fitted over rim of the container when the abutment surface is seated on the shoulder.

18. An apparatus according to claim 17, the apparatus being configured so that after the lid has been fitted over the open end of the container, the abutment surface may be initially spaced from the shoulder, only to be brought into abutment with the shoulder upon the application of subsequent pressure.

19. An apparatus according to claim 13, wherein the shoulder is specifically configured to deform under the application of pressure, for creating a tightly nested abutment with an underside portion of a lid applied to the open end of the container.

20. An apparatus according to claim 19, wherein the shoulder comprises a bubble type formation which is intended to be depressed by the lid.

21. An apparatus according to claim 19, wherein the shoulder defines an initial angle with the side walls of the container and is intended to be displaced downwards from its initial angle by the lid.

22. An apparatus according to claim 13, wherein the shoulder is provided at a depth of between 5 and 40 mm from the open end of the container.

23. Apparatus for dispensing blended beverages, the apparatus comprising a disposable plastics container for dispensing the blended beverage, and a blending lid for mounting over an open end of the container, the lid carrying a rotatable impeller, wherein the apparatus is intended to be inverted for the purpose of a blending operation, so that the lid is lowermost, and wherein the container is specifically configured for receiving the blending lid.

24. Apparatus according to claim 23, wherein the container has an open end and includes an internal shoulder spaced from its open end for seating a lid inside the open end of the beaker.

25. Apparatus according to claim 23, wherein the container is transparent or translucent, but incorporates a masked region adjacent the open upper end thereof, so that any detritus that might be left on the inside of the container adjacent its upper end as a result of blending is not distinguishable through the walls of the container.

26. A disposable plastics drinks beaker having tapering side walls leading to an open end, a radially projecting lip or rim about said open end, the beaker being configured to be nestable with other beakers of the same kind and configuration, one inside another with the base of a first beaker located substantially towards the base of a subjacent beaker, the disposable beaker being configured for use as part of an apparatus for preparing blended beverages.

27. A beaker according to claim 26, wherein the beaker includes an internal shoulder spaced from the lip, the shoulder being configured to act as a seating for a lid carrying a rotatable impeller, inside the open end of the beaker.

28. A beaker according to claim 26, wherein the beaker is transparent or translucent, but incorporates a masked region adjacent the open upper end thereof, so that any detritus that might be left on the inside of the vessel adjacent its upper end as a result of blending is not distinguishable through the walls of the beaker.

29. An open ended container for dispensing a blended beverage, the container including an internal shoulder spaced from the open end of the container for seating a lid on the container inside the open end of the container.
